(19) United States
(12) Patent Application Publication
(10) Pub. No.: US 2010/0114955 A1
(43) Pub. Date: May 6, 2010

(54) Method For Sharing Inventory

(75) Inventor: Kris Thayer, Jackson, MI (US)

Correspondence Address: YOUNG BASILE, 3001 WEST BIG BEAVER ROAD, SUITE 624, TROY, MI, 48084, US

(73) Assignee: Marine Dealer Trader, LLC, Jackson, MI (US)

(21) Appl. No.: 12/183,316

(22) Filed: Jul. 31, 2008

Related U.S. Application Data
(60) Provisional application No. 60/963,219, filed on Aug. 2, 2007.

(51) Int. Cl. G06F 17/30

(52) U.S. Cl. 707/780; 707/E17.014

(57) ABSTRACT

A method for sharing inventory, comprising the steps of collecting data regarding a user; receiving search criteria from a user; determining a search scope based on the user data; and outputting search results corresponding to the search scope and the search criteria.

### CROSS-REFERENCE TO RELATED APPLICATIONS

This application is related to, and claims the benefit of priority from, U.S. Provisional Patent Application Ser. No. 60/963,219, filed Aug. 2, 2007.

### FIELD OF THE INVENTION

The invention relates to the field of inventory management, and more particularly to a method for sharing inventory among multiple parties.

### BACKGROUND OF THE INVENTION

Sales of vehicles and vehicle parts are handled by dealers who are authorized by one or more, and typically several, manufacturers to sell vehicles produced by that manufacturer as well as replacement parts for those vehicles. However, due to logistical and financial constraints, dealers are only able to stock a limited number of new vehicles at any one time. Often, this results in a particular dealer being unable to fulfill the request of a customer without resort to ordering a custom-built vehicle directly from the manufacturer. Instead of waiting for a custom-built vehicle, the customer will often seek out a second dealer who may have a suitable vehicle in stock, causing the first dealer to lose a sale, or the customer may simply decide not to purchase the vehicle in light of not being able to purchase the desired vehicle in the desired time frame. These issues are particularly prevalent among marine dealers who sell recreational boats, as individual dealers have not conventionally worked cooperatively with one another.

### SUMMARY OF THE INVENTION

The present invention includes a method for sharing inventory. The method may include the steps of collecting data regarding a user, receiving search criteria from a user, determining a search scope based on the user data, and outputting search results corresponding to the search scope and the search criteria. The method may further include the steps of collecting information regarding a credential supplied by a third party as part of the user data and determining the search scope based at least in part on the information regarding the credential.

The credential may include an authorization to sell one or more products. The products may be vehicles. Furthermore, the products may be marine vehicles. Alternatively, the products may be vehicle parts. As a further alternative, the products may be marine vehicle parts.

The third party may be a vehicle manufacturer. Furthermore, the third party may be a marine vehicle manufacturer and the credential may include an authorization to sell one or more marine vehicles.

### BRIEF DESCRIPTION OF THE DRAWINGS

The foregoing and other features and aspects of the instant invention will be better understood with reference to the following description and accompanying drawings, of which:

FIG. 1 is a diagrammatic representation of implementation of the present invention via one or more computers;

FIG. 2 is a diagrammatic depiction of exemplary data which may be employed in the method of the present invention;

FIG. 3 comprises a flow chart showing a method for sharing dealer inventory according to the present invention;

FIG. 4 depicts an exemplary main menu screen according to a computer-implemented embodiment of the present invention;

FIG. 5 depicts an exemplary manufacturer inventory search selection screen according to a computer-implemented embodiment of the present invention, wherein the scope of the search has been limited following the determination of authorization;

FIG. 6 depicts an exemplary manufacturer inventory search results output screen according to a computer-implemented embodiment of the present invention;

FIG. 7 depicts an exemplary manufacturer inventory details screen according to a computer-implemented embodiment of the present invention;

FIG. 8 depicts an exemplary dealer inventory search selection screen according to a computer-implemented embodiment of the present invention;

FIG. 9 depicts the exemplary inventory search selection screen of FIG. 8, wherein the scope of the search has been limited following the determination of authorization;

FIG. 10 depicts the exemplary inventory search selection screen of FIG. 8, wherein the scope of the search is further limitable by model;

FIG. 11 depicts the exemplary inventory search selection screen of FIG. 8, wherein the scope of the search is further limitable by engine type;

FIG. 12 depicts an exemplary dealer inventory search results output screen according to a computer-implemented embodiment of the present invention;

FIG. 13 depicts an exemplary dealer inventory details screen according to a computer-implemented embodiment of the present invention;

FIG. 14 depicts an exemplary parts search selection screen according to a computer-implemented embodiment of the present invention;

FIG. 15 depicts an exemplary parts search criteria input screen according to a computer-implemented embodiment of the present invention;

FIG. 16 depicts an exemplary parts search results output screen according to a computer-implemented embodiment of the present invention;

FIG. 17 depicts an exemplary warranty registration list screen according to a computer-implemented embodiment of the present invention;

FIG. 18 depicts an exemplary warranty registration detail screen according to a computer-implemented embodiment of the present invention;

FIG. 19 depicts an exemplary warranty claim submission screen according to a computer-implemented embodiment of the present invention;

FIG. 20 depicts an exemplary warranty claim submission screen according to a computer-implemented embodiment of the present invention;

FIG. 21 depicts an exemplary warranty claim submission screen according to a computer-implemented embodiment of the present invention;

FIG. 22 depicts an exemplary inventory addition screen according to a computer-implemented embodiment of the present invention;

FIG. 23 depicts an exemplary inventory management screen according to a computer-implemented embodiment of the present invention;

FIG. 24 depicts an exemplary part addition screen according to a computer-implemented embodiment of the present invention; and

FIG. 25 depicts an exemplary entity information screen according to a computer-implemented embodiment of the present invention.

### DETAILED DESCRIPTION

Referring to the drawings, the present invention will now be described in detail with reference to the disclosed exemplary embodiment.

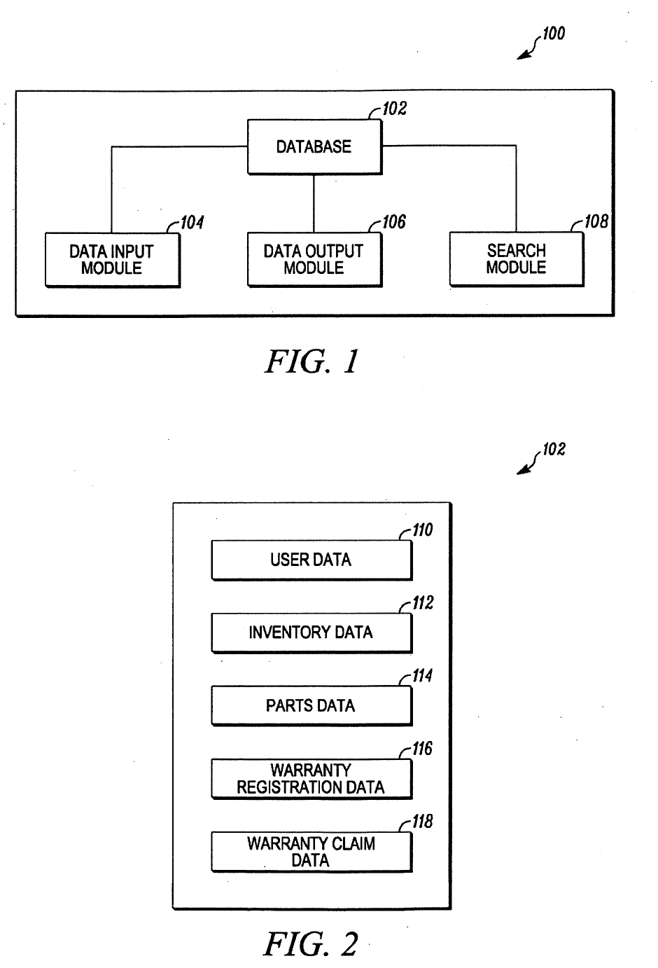

As shown in FIGS. 1-3, a method for sharing vehicle dealer inventory 10 of the present invention may be implemented using a computer software system 100. By using the method 10, individual users or entities are able to access data regarding other users or entities. In the exemplary embodiment shown and described herein, the entities in question are marine vehicle dealers and marine vehicle manufacturers, and the method 10 shown and described is used in connection with sharing inventory information regarding marine vehicles and parts for marine vehicles among marine dealers and marine manufacturers. However, it should be understood that the method 10 is not limited to marine vehicles and/or parts and marine dealers and/or manufacturers. Rather, the method 10 could be applied to sharing inventory information regarding any type of vehicle or vehicle parts among vehicle dealers and manufacturers, or the method 10 could be applied to sharing inventory information between dealers and manufacturers of any number of non-vehicle products.

The computer software system 100 may be a database driven computer software application that is hosted on a World Wide Web server for access by its users remotely, through the use of web pages, as will be described in detail herein. The system 100 includes a database 102 for storing information, a data input module 104 for gathering information, a data output module 106 for delivering information to the user, and a search module 108 by which users may query the data in the database 102 and thereby receive results from the data output module 106.

The database 102 may store a wide variety of information collected and otherwise used in implementing the method 10. In particular, the database 102 may store user data 110, inventory data 112, parts data 114, warranty registration data 116, and warranty claim data 118. The user data 110 includes information that identifies each user of the system including, but not limited to, contact information of the user and a list of boat model designations for which that user is either an authorized dealer or manufacturer. The inventory data 112 includes data corresponding to the boats in a particular entity's inventory, including, for example, the model, size and color of the boat, and whether the boat is new or used. The parts data 114 stores a plurality of data entries corresponding to replacement parts in particular dealers' inventories. The warranty registration data 116 allows dealers to collect and store information regarding the warranty registrations of vehicles that they have sold to customers, including the contact information of the purchaser, identifying information for the vehicle, and the date of sale. The warranty registration data 116 may be transmitted to the manufacturer and shared with other dealers to aid in disposition of warranty claims. The warranty claim data 118 allows dealers to enter information regarding a warranty claim for subsequent review and processing by the manufacturer, as will be explained in detail herein.

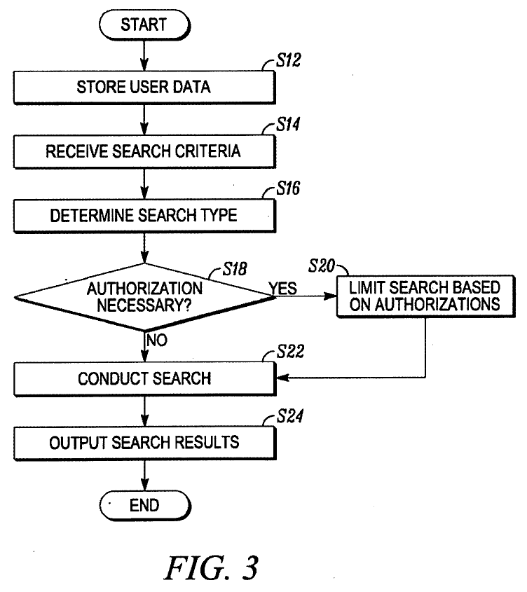

The steps of the method 10 will be best understood with reference to the flowchart shown in FIG. 3, which generally describes the manner in which a user performs a search of the inventory of other dealers and manufacturers for a desired product, according to the method 10. Initially, data regarding each user is collected by storing the user data 10 in step S12, using the data input module 104 of the system 100. The user data 110 collected in step S12 may include information regarding a credential that is supplied to the user by a third party. For example, the credential could be an authorization to sell one or more products, such as marine vehicles, and the third party could be a manufacturer of the product, such as a marine vehicle manufacturer. It should be understood that the step of storing user data S12 need not be performed every time a search is performed, but rather, the user data 110 need only be provided once, as the data input module 104 of the system 100 is operable to store the user data 110 in the database 102 for use in connection with subsequent searches.

When a user desires to conduct a search of the inventories of other entities, the search module 108 of the system 100 first receives search criteria from the user in step S14. The search criteria may include the type of vehicle that the user is interested in, whether a new or used vehicle is desired, the desired make, model and color desired, etc. After receiving the search criteria, the system 100 may classify the search according to the type of search requested in step S16. For example, the search may be classified according to whether vehicles or parts are being searched for, or whether new or used vehicles are being searched for.

Next, the method 10 proceeds by determining whether authorization is required to perform the search requested by the search criteria that was supplied by the user in step S14. For example, if the search criteria requests information regarding boats that are only allowed to be sold by authorized dealers, the system judges that authorization from a third party is required, and thus, the method 10 proceeds to step S20. Alternatively, if it is determined in step S18 that authorization is not required for the type of search requested, the method 10 proceeds from step S18 directly to step S22.

In step S20, the search scope is determined based on the user data 110 that was supplied by the user in step S12. More particularly, where a manufacturer requires that its dealers be authorized, the search scope is limited based on whether or not the user possesses the requisite authorization credential that is supplied by the manufacturer. If the user does not possess the requisite credential, the search scope is limited to exclude those entries for which authorization is required.

In step S22, the search is conducted in light of the search criteria supplied to the search module 108 by the user in step S14, and further based on the search scope that was determined in step S20, if applicable. It should be understood that the search scope determined in step S20 could be applied in several ways. For example, the search module 108 could be configured to prevent searching of portions of the database 102 that are identifiable as being outside of the scope set in step S20. Alternatively, the search module 108 could initially search all relevant portions of the database 102 without regard to the scope determined in step S20, and subsequently apply the scope by filtering the results based on the search scope determined in step S20. Once the search is completed, the method 10 proceeds to the step of outputting search results in S24, using the data output module 106. Although the foregoing is described in connection with a search that produces final results, it should be understood that the method 10 could be applied iteratively, wherein the method 10 would be applied multiple times in succession. Moreover, the method 10 could be applied during a single iteration of a search, where previous or subsequent searching and/or filtering iterations do not apply the method 10.

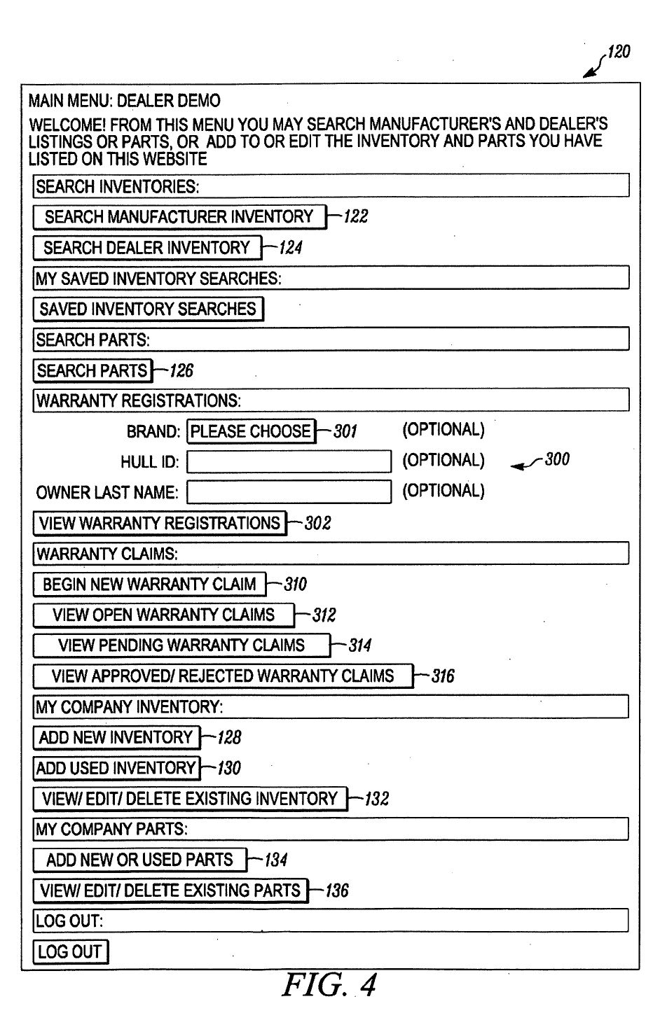

In order to access the various functions of an exemplary embodiment of the system 100, a main menu screen 120 is provided, as shown in FIG. 4. The main menu screen 120 may be used to invoke the search module 108 by selecting the search manufacturer inventory option 122, the search dealer inventory option 124, or the search parts option 126.

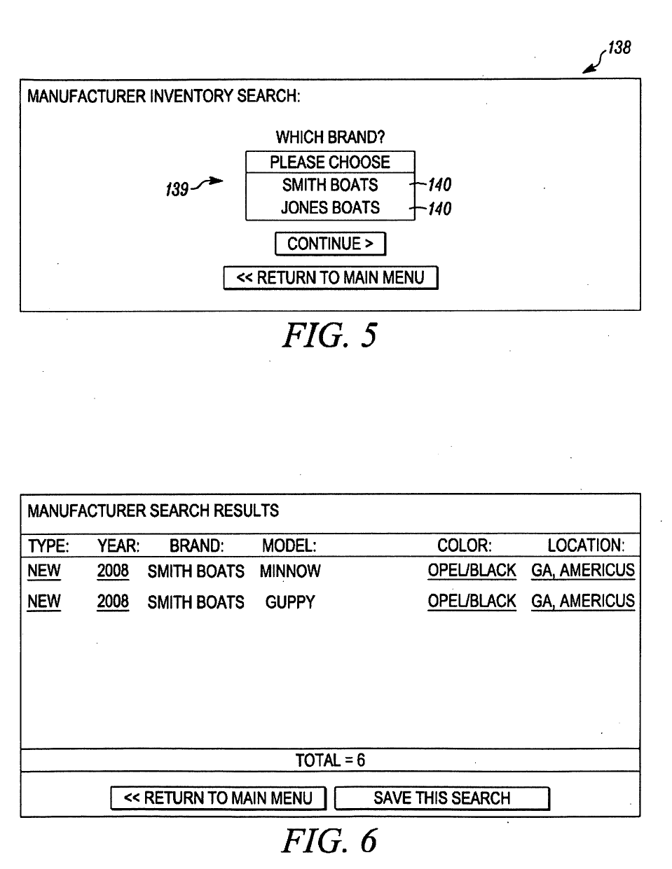

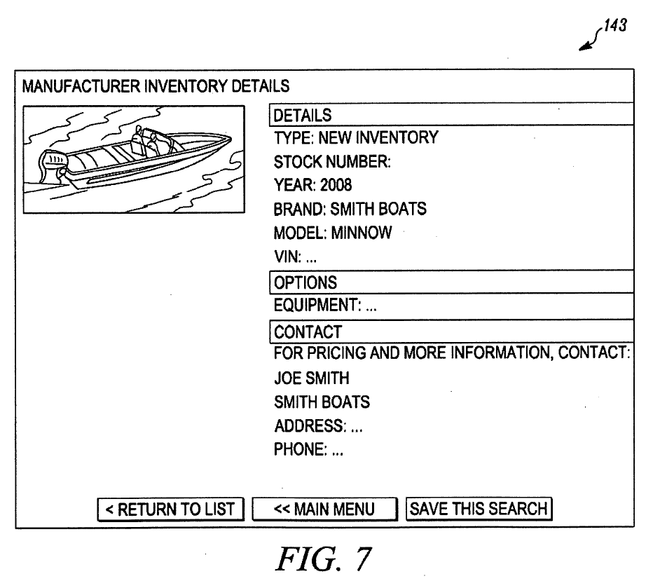

If the search manufacturer inventory option 122 is selected, the search type is designated a new search, for which authorization is required in step S18 of the method 10. The user is then presented with the brand selection screen 138, as shown in FIG. 5. The brand selection screen 138 presents a selection box 139 that lists the names of available brands 140. The brands 140 displayed in the selection box may be provided as search results according to the method 10. In this example, the user's selection of the manufacturer inventory option 122 constitutes the search criteria that is received by the system 100 in step S14. The system 100 then populates the selection box 139 in light of the authorizations possessed by the user, as reflected in the user data 110. After the user selects one or more of the brands 140, the search module 108 and the data output module 106 cooperate to provide manufacturer search results screen 141, as shown in FIG. 6. On selecting a particular entry 142 from the manufacturer search results screen 141, the system provides a manufacturer inventory details screen 143 that includes information regarding a boat and the contact information of the relevant manufacturer, as shown in FIG. 7.

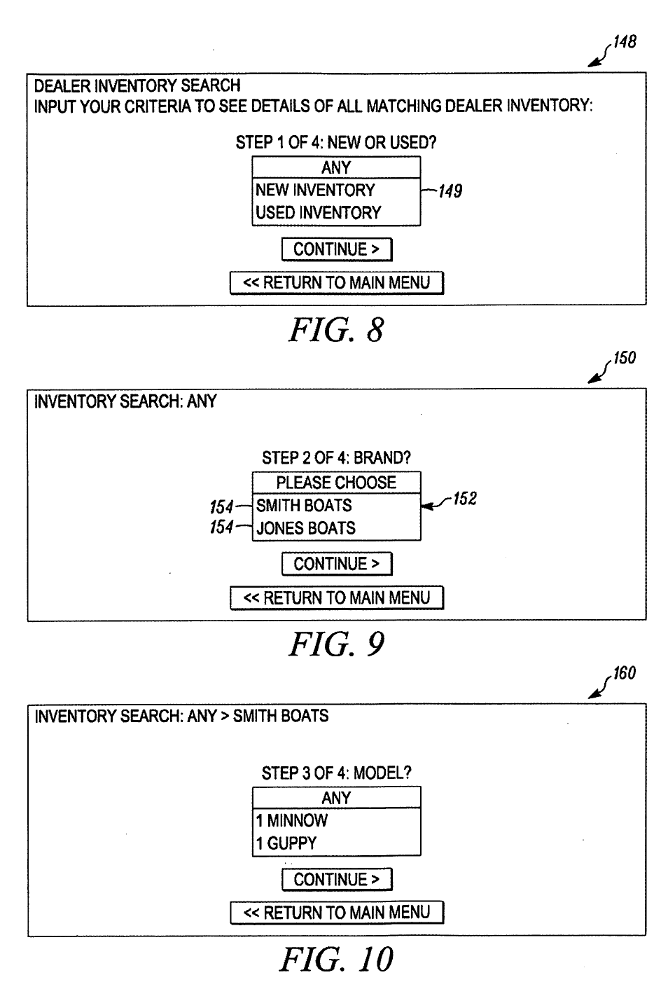

If the search dealer inventory option 124 is selected, the system 100 then presents an inventory type selection screen 148, as shown in FIG. 8. On the inventory type selection screen 148, the user is prompted to specify whether they wish to search for new inventory or used inventory, and this selection is input using a selection box 149. If, using the selection box 149, the user indicates that they are searching for new inventory, it will be determined in step S18 of the method 10 that authorization is needed. If the user, using the selection box 149, indicates that they are searching for used inventory, it will be determined in step S18 of the method 10 that authorization is not required. In the case that used inventory has been selected, and thus, authorization is not required in step S18, the user proceeds from selection screen 148 to further screens which utilize the search module 108 to perform this step of conducting a search in S22 of the method 10 and then using the data output module 106 to output the search results according to step 24 of the method 10.

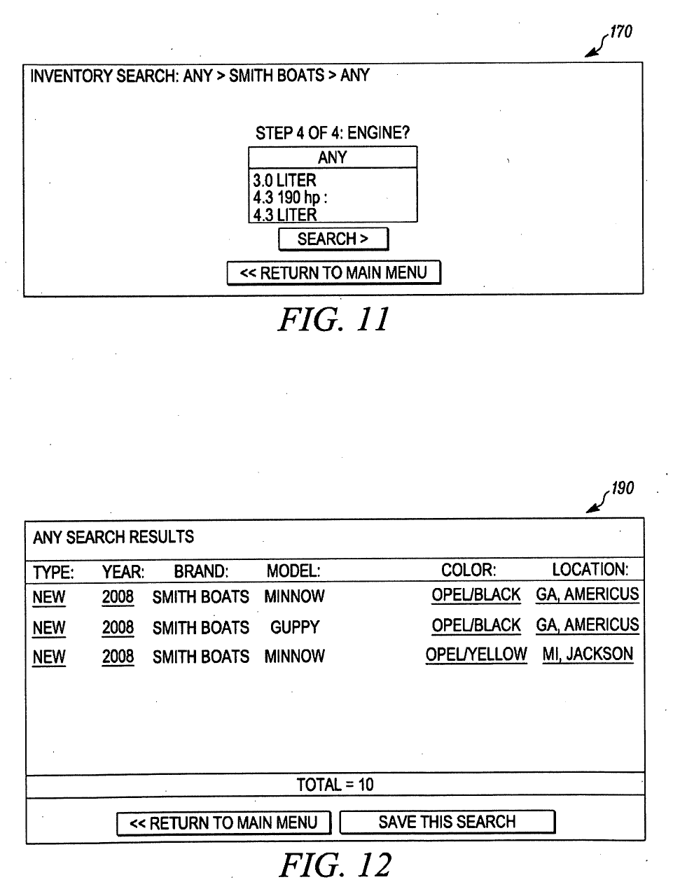

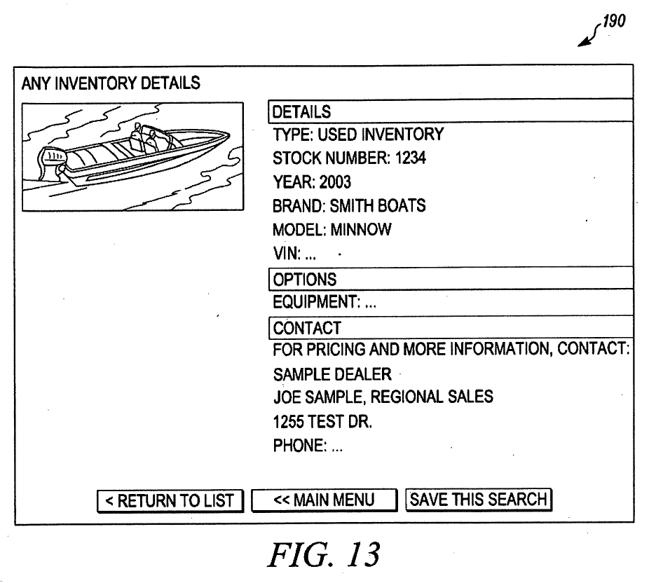

In order to provide users access only to information regarding those products which they are authorized to sell, the scope of the search is limited in S20 of the method 10 when it has been determined in S18 of the method 10 that authorization is required, as shown in FIG. 9. In particular, the search module 108 generates a brand selection screen 150 in which a selection box 152 is populated with the names of the brands 154 in which the user is authorized to deal. In generating the new inventory search screen 150, the search module 108 utilizes the user data 110 from the database 102 to determine which brands 154 the user is authorized to sell, and then displays only those particular brands 154 in the selection box 1 52. After the user has selected the brand in which they are interested using the brand selection screen 150, the user may then be prompted by the search module 108 to further define the scope of the search, for example, using a model selection screen 160, as shown in FIG. 10, and in engine selection screen 170, as shown in FIG. 11. While these selections all correspond to the step of conducting the search S22 of the method 10, it should be understood that the particular models of boats for which the user is authorized could be limited, and thus, the selections on the model selection screen 160, engine selection screen 170 or other data entry screen could be limited using the method 10. Once the user has defined the search using the foregoing inputs, the data output module 106 performs the step of outputting search results S24 of the method 10, thereby producing a new inventory search results screen 180, as shown in FIG. 12. The contents of the new inventory search results screen 180 are generated by the data output module 106 on the basis of the inputs provided to the search module 108 by the user as well as the inventory data 112 stored in the database 102. Typically, the new inventory search results screen 180 displays a plurality of results 182. After the user selects one of the plurality of results 182, the data output module 106 accesses the inventory data 112 regarding that particular result 182 and thereby generates a result detail screen 190, as shown in FIG. 13.

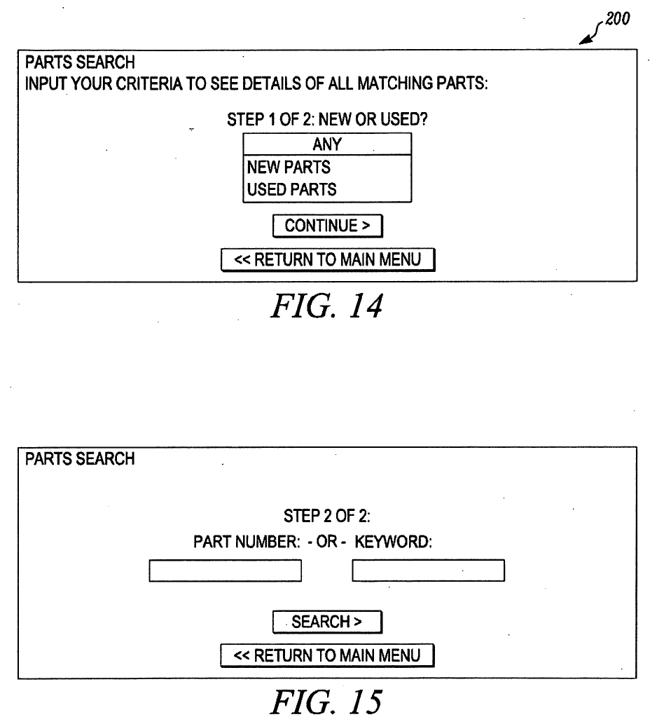

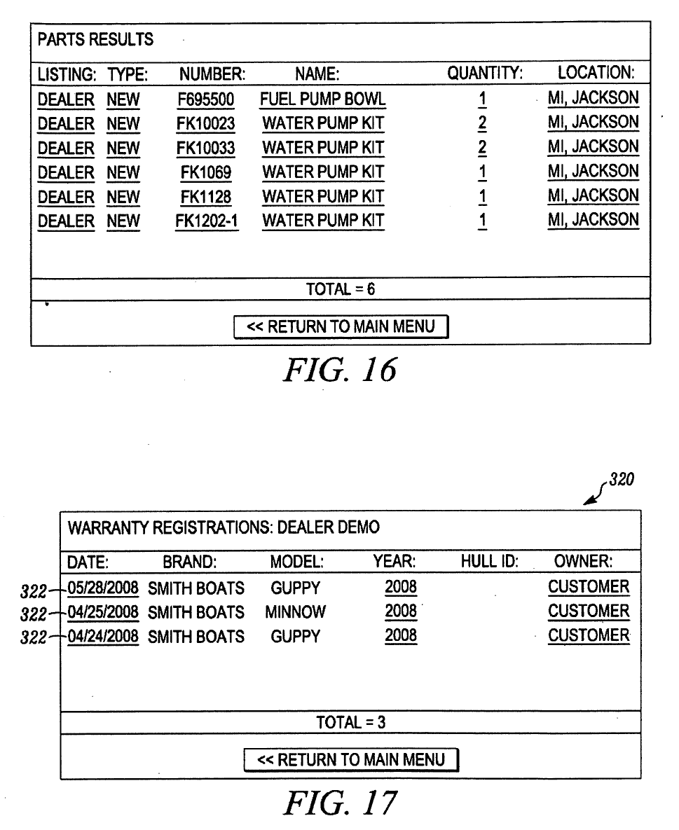

Referring again to main menu screen 120 of FIG. 4, the system 100 is further operable to allow parts searching upon the user's operation of the parts search selection button 126. Upon doing so, the data input module 104 of the system 100 produces a parts search criteria screen 200, as shown in FIG. 14, wherein the user is presented with a new or used parts selection box 202. After making appropriate selection using the selection box 202, the user is directed to a second parts search criteria screen 210, as shown in FIG. 15, wherein the user may supply one or more criteria 212 to the data input module 104. The criteria entered into the second parts search criteria screen 210 may correspond to a desired part number or key word. Of course, the scope of the search may be limited according to the user's authorizations using the method 10, so that only those parts corresponding to boats which the user is authorized to sell are returned. After the search criteria has been appropriately defined and the search scope has been limited, if necessary, the search is conducted by the search module 108 based on the parts data 114 of the database 102, and the output module 106 of the system 100, generates a parts results screen 220 showing a plurality of parts listings 222 that meet the user's specified criteria, as shown in FIG. 16.

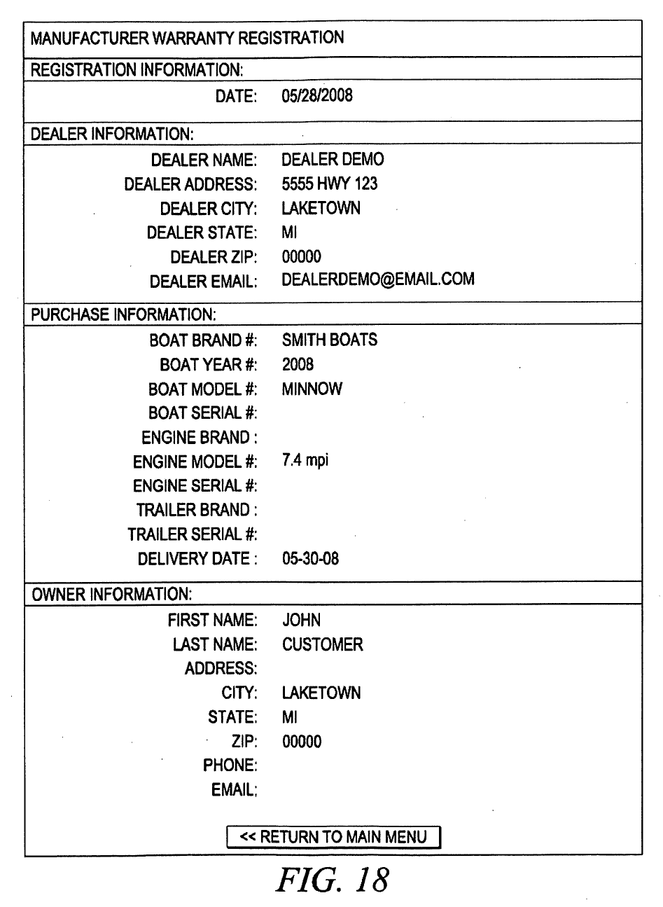

To allow manufacturers and dealers to share information regarding warranty registrations and warranty claims, the main menu screen 120 of FIG. 4 includes a warranty registration search section 300, a new warranty claim selection button 310, a view open claims selection button 312, a view pending claims selection button 314, and a view approved/rejected warranty claims button 316. The warranty registration search section 300 allows the user to search vehicle warranty records. The brand selection box 301 may present the user with a list of authorized brands that is generated using the method 10. After the user selects a brand from the brand selection box 301, actuation of a view warranty registrations button 302 of the warranty registration search section 300 causes the system 100 to present a warranty registration list screen 320 to the user, as shown in FIG. 17, which is produced based on the warranty registration data 116 that is stored in the database 102. Upon selecting a particular warranty record 322 from the warranty registration list screen 320, the user is presented with a warranty registration detail screen 330, as shown in FIG. 18, which provides details regarding the vehicle and may also provide warranty information.

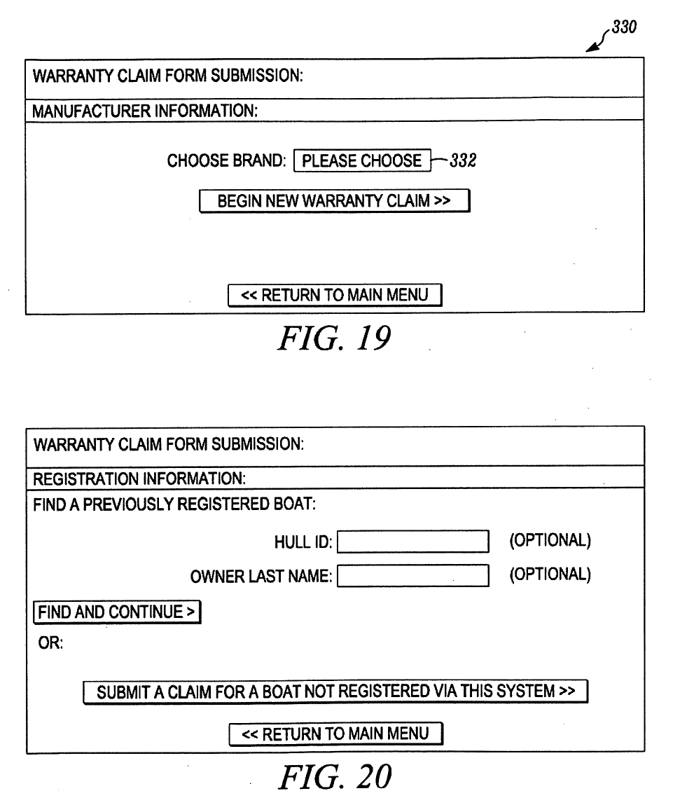

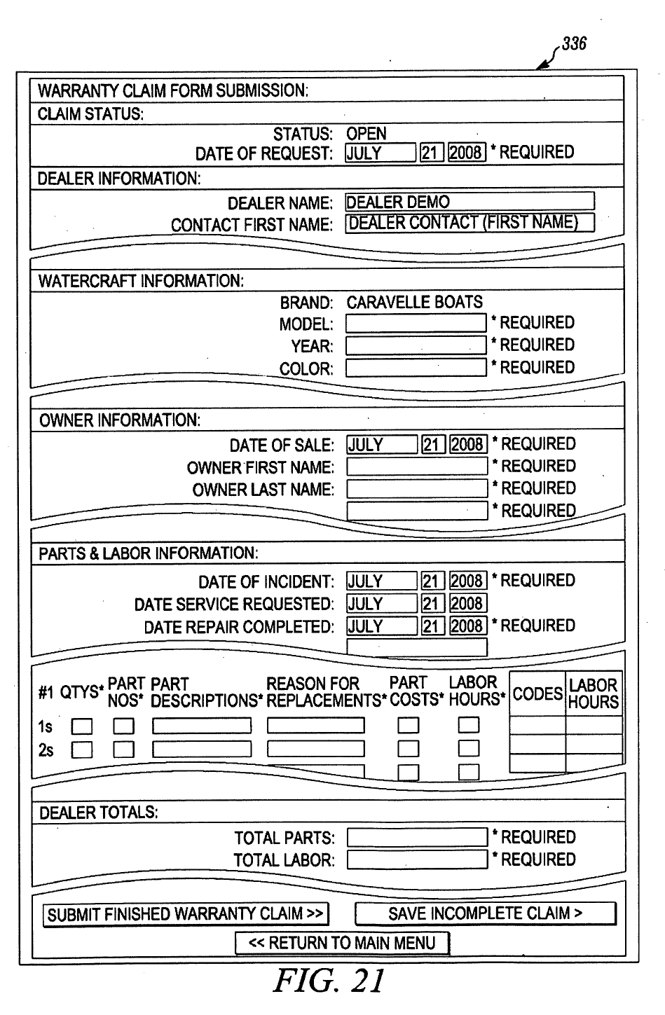

Upon actuation of the new warranty claim selection button 310 of screen 120, the system presents a first warranty claim submission screen 330 to the user, as shown in FIG. 19. The first warranty claim submission screen 330 includes a brand selection box 332 that allows the user to specify the brand of vehicle for which a warranty claim is being submitted. The list of brands presented by the brand selection box 332 may be a list of the user's authorized brands, which is generated using the method 10. After selecting the appropriate brand on the first warranty claim submission screen 330, the user is presented with a second warranty claim submission screen 334, as shown in FIG. 20, where identifying information regarding the boat may be provided, in order to retrieve information regarding the boat in question from the database 102 so that portions of the third warranty claim submission screen 336, as shown in FIG. 21, may be filled in programmatically by the system 100, upon presentation of the third warranty claim submission screen 336 to the user. The third warranty claim submission screen 336 allows the user to enter substantive details regarding the claim being made, which are stored in the warranty claim data 118 of the database 102. The user may submit the claim using the submission button 338, or save an incomplete form for later completion using the save button 340, in which case the saved form may be accessed using the view open claims selection button 312 on the main menu screen 120 of FIG. 4. The user may review previously submitted pending claims by actuating the view pending claims selection button 314 of the main menu screen 120, which presents the user with a list of pending claims, or may review details of the manufacturer's approval or denial of claims by actuating the view approved/rejected warranty claims button 316.

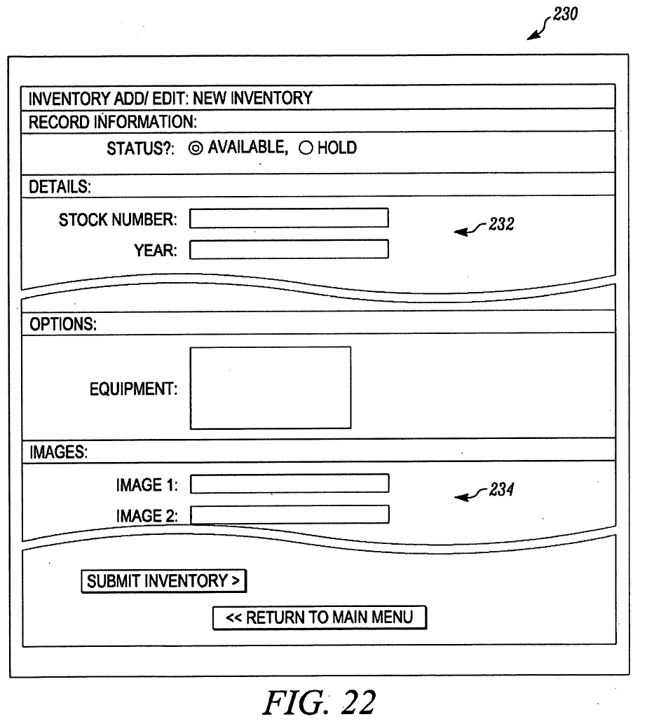

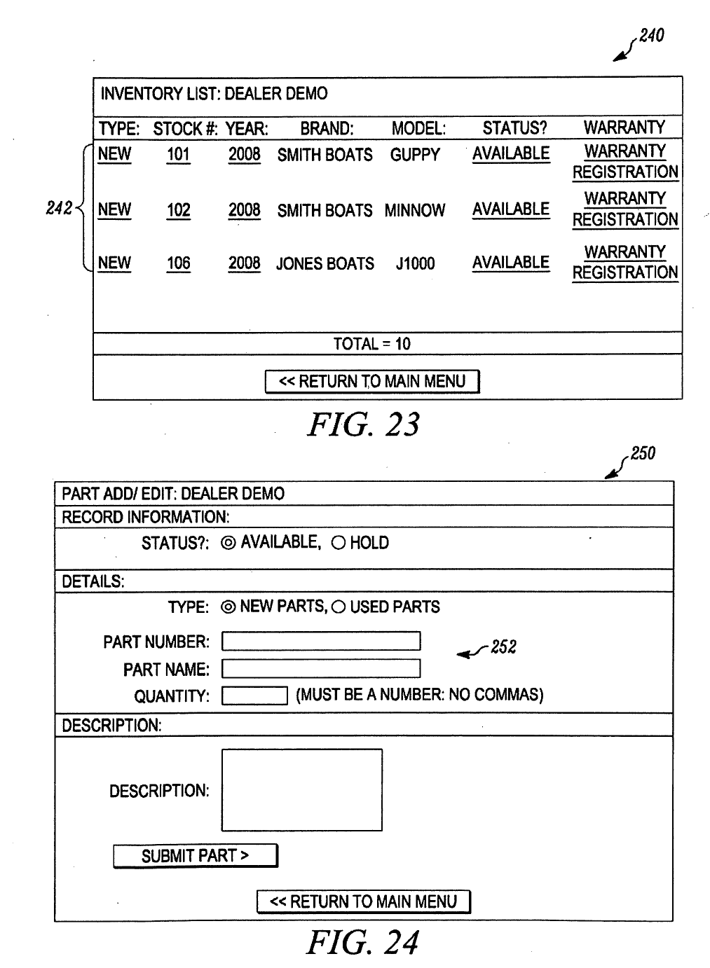

In order to allow the user to enter data into the system regarding the user's available inventory, the screen 120 of FIG. 4 further provides an “add new inventory” button 128, and add used inventory button 130, and an existing inventory management button 132. Selection of either the add new inventory button 128 or the add used inventory button 130 takes the user to an inventory addition screen 230, as shown in FIG. 22, which is directed toward the addition of either new or used inventory as desired. The new inventory addition screen 230 includes a plurality of data fields 232 wherein information regarding the inventory may be supplied to the software 100 for subsequent storage and the inventory data 112 of the database 102. A plurality of images 234 may also be supplied to the system 100 through the inventory addition screen 230 for storage in the inventory data 112 of the database 102. Upon selecting the inventory management button 132 on the screen 120, the user is directed to an inventory management screen 240, as shown in FIG. 23, wherein the user's existing inventory as stored in the inventory data 112 of the database 102 may be displayed for the user's review. In particular, the screen 240 provides a plurality of entries 242 corresponding to the items in the user's inventory. Selection of any of the entries 242 will cause the data input module 104 of the system 100 to generate a screen similar to the inventory addition screen 230 where the entry 242 may be modified or deleted.

In order to allow the user to manage their parts' listings, the screen 120 of FIG. 4 also includes an add parts button 134 and a parts inventory management button 136. Operation of the add parts button 134 takes the user to a part addition screen 250, as shown in FIG. 24, wherein a plurality of data fields 252 allow the user to supply data to the data input module 104 for inclusion in the parts data 114 of the database 102.

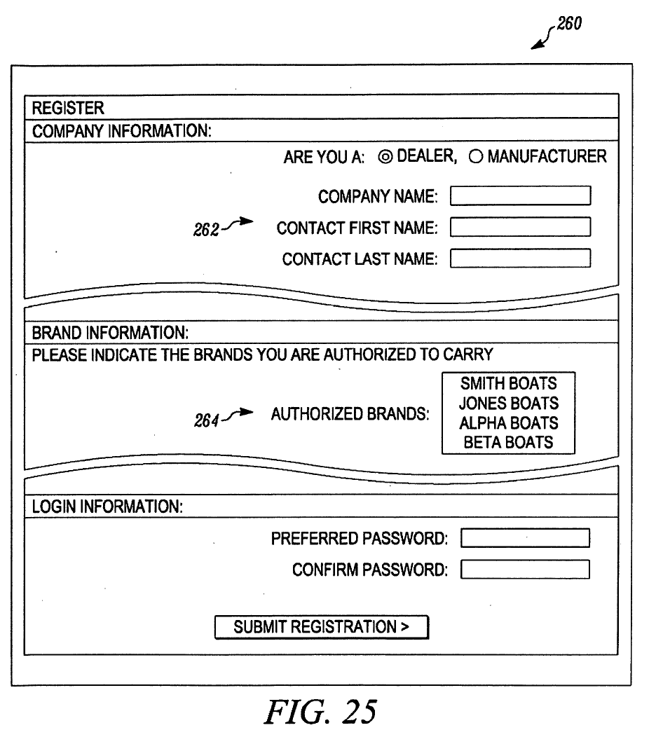

In order to allow the user to provide information regarding their company and regarding those brands for which they are an authorized dealer or manufacturer, the data input module 104 of the system 100 further provides an entity information screen 260, as shown in FIG. 25. The entity information screen 260 includes a plurality of data fields 262 in which the user may supply criteria for inclusion in the user data 110 of the database 102. The information provided in the data fields 262 may be for example the name of the company, name and address of a contact person, the location of the company, and contact information for the company. Also, the entity information entry screen provides an authorized brand selection box 264. The authorized brands selection box 264 lists a plurality of marine vehicle brands from which the user may select those brands which it is authorized to sell. This information is then stored in the user data 110 and used by the method 10 in step S20 to limit searches conducted by that user.

It will be appreciated that the present invention permits the authorized dealers of a particular manufacturer's boats to locate boats that may be available in the inventories of other authorized dealers, thereby facilitating sales without the need to custom order boats from the manufacturer. Of course, the subject invention is not limited to boats and dealers of boats, but rather, the subject invention may be utilized with any vehicle and their associated dealers.

Of course, the foregoing is merely illustrative of the present invention, and those of ordinary skill in the art will appreciate that many additions and modifications to the present invention, as set out in this disclosure, are possible without departing from the spirit and broader aspects of this invention as defined in the appended claims.

1. A method for sharing inventories, comprising the steps of:
collecting user data regarding a user;
receiving search criteria from a user;
determining a search scope based on the user data; and
outputting search results corresponding to the search scope and the search criteria.

2. The method of claim 1, further comprising the steps of:
collecting information regarding a credential supplied by a third party as part of the user data; and
determining the search scope based at least in part on the information regarding the credential.

3. The method of claim 2, wherein the credential includes an authorization to sell one or more products.

4. The method of claim 3, wherein the products are vehicles.

5. The method of claim 3, wherein the products are marine vehicles.

6. The method of claim 3, wherein the products are vehicle parts.

7. The method of claim 3, wherein the products are marine vehicle parts.

8. The method of claim 2, wherein the third party is a vehicle manufacturer.

9. The method of claim 2, wherein the third party is a marine vehicle manufacturer and the credential includes an authorization to sell one or more marine vehicles.

10. A method for sharing inventory, comprising the steps of:
collecting user data regarding a user, the user data including authorizations supplied by a third party, and the authorizations corresponding to one or more categories of a plurality of categories;
receiving search criteria from a user;
determining a search scope based on the user data, wherein the search scope is limited to those categories corresponding to the authorizations possessed by the user; and
outputting search results corresponding to the search scope and the search criteria.

11. The method of claim 10, wherein the authorization includes an authorization to sell one or more products.

12. The method of claim 11, wherein the products are vehicles.

13. The method of claim 11, wherein the products are marine vehicles.

14. The method of claim 11, wherein the products are vehicle parts.

15. The method of claim 11, wherein the products are marine vehicle parts.

16. The method of claim 10, wherein the third party is a vehicle manufacturer.

17. The method of claim 10, wherein the third party is a marine vehicle manufacturer and the authorization includes an authorization to sell one or more marine vehicles.

18. The method of claim 10, wherein each category of the plurality of categories corresponds to a particular make of marine vehicle, the third party includes a marine vehicle manufacturer, and the authorization includes an authorization to sell the particular make of marine vehicle associated with the corresponding category.

19. A method for sharing inventory, comprising the steps of:
collecting user data regarding a user, the user data including authorizations to sell one or more vehicles supplied by a vehicle manufacturer;
receiving search criteria from a user;
generating search results based on the search criteria, the search results including a plurality of vehicle listings;
filtering the search results based on the user data, wherein the search results are filtered to exclude vehicle listings for which authorization is required and is not possessed by the user to provide filtered search results; and
outputting the filtered search results.

20. The method of claim 19, wherein the vehicles are marine vehicles and the vehicle manufacturer is a marine vehicle manufacturer.
